(19) United States
(12) Patent Application Publication
(10) Pub. No.: US 2013/0265520 A1
(43) Pub. Date: Oct. 10, 2013

(54) DISPLAY DEVICE

(71) Applicant: Japan Display East Inc., Mobara-shi (JP)

(72) Inventor: Shinji SHIMIZU, Atsugi-shi (JP)

(21) Appl. No.: 13/834,203

(22) Filed: Mar. 15, 2013

(30) Foreign Application Priority Data
Apr. 10, 2012 (JP) 2012-088870

(51) Int. Cl. G02F 1/1335

(52) U.S. Cl. CPC G02F 1/133608
USPC 349/58

(57) ABSTRACT

A liquid crystal display device includes a liquid crystal display panel, and a backlight. The backlight has a light guide plate, LEDs as a light source, and a reflection plate within a lower frame formed of a metal, wherein the LEDs are arranged in the inside at a bottom of the lower frame. Light is emitted from the LEDs in a direction in which the liquid crystal display panel is arranged, reflected at the reflection plate, and is incident on a side surface of the light guide plate.

### CLAIM OF PRIORITY

The present application claims priority from Japanese Patent Application JP 2012-088870 filed on Apr. 10, 2012, the content of which is hereby incorporated by reference into this application.

### BACKGROUND OF THE INVENTION

1. Field of the Invention

The present invention relates to a liquid crystal display device using LED as a backlight. The invention particularly relates to a liquid crystal display device excellent in heat dissipation from a light source and having less power consumption.

2. Description of the Related Art

Liquid crystal display devices includes: a TFT substrate having pixel electrodes, thin film transistors (TFT), etc. formed in a matrix; a counter substrate disposed in facing relation to the TFT substrate and having color filters, etc. formed at portions corresponding to the pixel electrodes of the TFT substrate; and liquid crystals put between the TFT substrate and the counter substrate. Images are formed by controlling the light transmittance of liquid crystal molecules for each pixel.

Since liquid crystal display devices can be reduced in thickness and weight, they have been used in various fields. Since liquid crystals per se do not emit light, a backlight is provided at the back of a liquid crystal display panel. Fluorescent lamps have been used as the backlight in liquid crystal display devices such as televisions having a relatively large-sized screen. However, since mercury vapors are sealed inside the fluorescent lamps, they result in large burden on global environments and the use of them has tended to be inhibited, particularly, in Europe, etc.

Then, LEDs (light emitting diodes) have been used as the light source of the backlight instead of the fluorescence lamps and liquid crystal display devices using the LED light source have been increasing year and year also in large-sized display devices such as televisions.

The LED type backlight includes a direct downward type in which LEDs are arranged directly below a diffusion plate or the like and a sidelight type in which light is incident from the side surface of a guide plate. The sidelight type backlight involves problems as to how to guide light from LEDs efficiently into the light guide plate and emit light in the direction of a liquid crystal display panel.

In JP-2003-121840-A, the height of the side surface of a light guide plate where the LEDs are arranged is increased, and an inclined surface is formed to reduce the thickness of the light guide plate at a portion where the liquid crystal display panel is disposed, thereby taking a greater amount of light from the LED into the light guide plate and reducing the entire thickness of the liquid crystal display device including the backlight.

In JP-2004-117435-A, a frame member for housing a light guide plate has a notch formed at the bottom of the frame member, LEDs are arranged in the notch, a circuit substrate having LEDs mounted thereon is disposed outside of the frame member, light from LEDs is introduced from the lower side of the light guide plate, and a resilient member is disposed between the circuit substrate and the LEDs for close adhesion between the light guide plate and the LEDs. Then, the light guide plate includes an inclination formed on the side of the upper surface thereof and light from the LEDs is reflected at the side to introduce the light to the inside of the guide plate.

### SUMMARY OF THE INVENTION

The technique described in JP-2003-121840-A has an advantage in that it can increase the amount of light from the LEDs taken from the side of the light guide plate but heat dissipation from the LEDs is not described. That is, in JP-2003-121840-A, the LEDs and a circuit substrate are bonded to a light shielding plate disposed above and suspended therefrom, but no consideration is taken for heat conduction from the LEDs.

Further, in the configuration described in JP-2004-117435-A, LEDs are closely adhered to the lower side of the light guide plate by using the resilient member but it neither describes nor suggests heat dissipation from the LEDs. That is, the LEDs are closely adhered to the lower portion of the light guide plate by the resilient member disposed between the circuit substrate and LEDs, but the heat generated from LEDs is not conducted to a casing made of metal or the like. That is, in JP-2004-117435-A, since LEDs are arranged in a closed space and mounted by way of the lower surface of the light guide plate and the resilient member on the circuit substrate, heat cannot be dissipated sufficiently from the LEDs.

The present invention intends to provide a sidelight type backlight using LEDs that allows light from the LEDs to be taken sufficiently into a light guide plate and heat to be dissipated sufficiently from the LEDs. The invention also intends to provide such configuration without increasing the size of a frame of a liquid crystal display device, that is, without increasing the planar size of the liquid crystal display device.

The present invention overcomes the foregoing problems and provides the following specific configuration.

(1) A liquid crystal display device comprising: a liquid crystal display panel, and a backlight, wherein the backlight has a light guide plate, LEDs as a light source, and a reflection plate within a lower frame formed of a metal, the LEDs are arranged in the inside at the bottom of the lower frame, and light is emitted from the LEDs in the direction in which the liquid crystal display panel is arranged, reflected at the reflection plate, and incident on the side surface of the light guide plate.

(2) A liquid crystal display device according to the configuration (1) described above, wherein the lower frame has an outwardly convex shape formed at a portion thereof, and the LEDs are arranged in a concave portion of the lower frame that corresponds to the portion having the outwardly convex shape.

(3) A liquid crystal display device according to the configuration (1) described above, wherein fins are formed at the outside of the lower frame in association with the LEDs arranged inside of the lower frame.

According to the invention, since the amount of light incident from the LEDs to the light guide plate can be increased and heat from the LEDs can be dissipated efficiently, the efficiency of LED is not lowered and, accordingly, a liquid crystal display with high brightness can be provided. Further, since lowering of the emission efficiency can be prevented, power consumption can be saved. Further, the effect described above can be obtained without increasing the planar outer size of the liquid crystal display device.

### BRIEF DESCRIPTION OF THE DRAWINGS

FIG. 1 is an exploded perspective view of a liquid crystal display device;

FIG. 2 is a cross sectional view of a backlight according to the invention;

FIG. 3 is a plan view of the backlight according to the invention;

FIG. 4 is a perspective view of a reflection plate;

FIG. 5 is a cross sectional view illustrating an example of a method of attaching the reflection plate;

FIG. 6 is a cross sectional view illustrating another example of a method of attaching the reflection plate;

FIG. 7 is a cross sectional view illustrating a further example of a method of attaching the reflection plate;

FIG. 8 is a cross sectional view of a backlight according to a second embodiment of the invention;

FIG. 9 is a cross sectional view of a backlight according to a third embodiment of the invention;

FIG. 10 is a cross sectional view of a backlight in a comparative example; and

FIG. 11 is a plan view of the backlight in the comparative example.

### DESCRIPTION OF THE PREFERRED EMBODIMENTS

The present invention will be described specifically with reference to preferred embodiments.

### First Embodiment

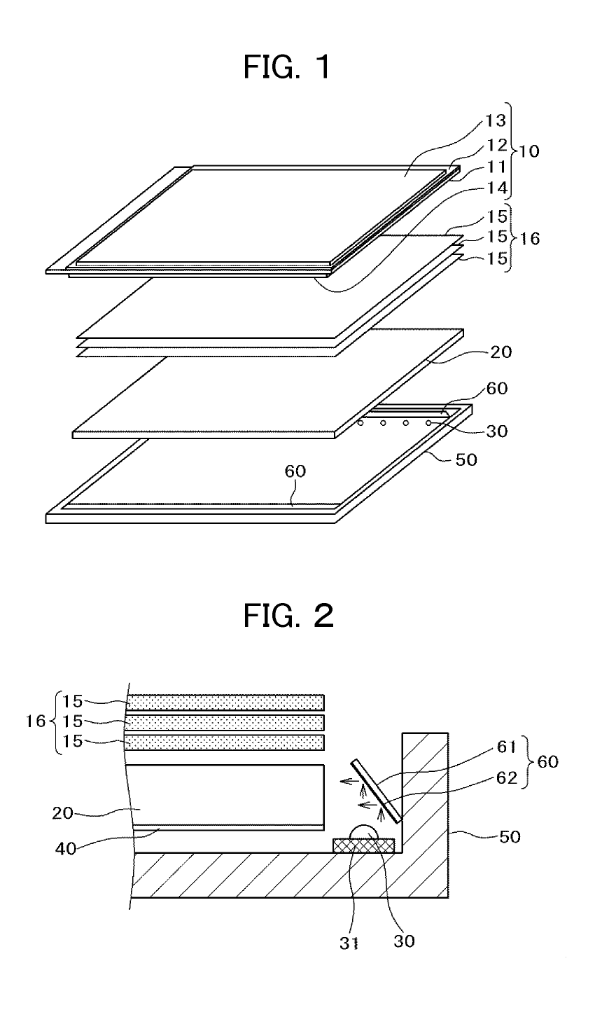

FIG. 1 is an exploded perspective view of a liquid crystal display device. FIG. 1 illustrates a liquid crystal display panel 10 and a backlight divisionally. In FIG. 1, a TFT substrate 11 in which a display region having TFTs and pixel electrodes arranged in a matrix, scanning lines, video signal lines, etc. are formed and a counter substrate 12 in which a color filter, etc. are formed are bonded by way of a not-illustrated adhesive material. Not illustrated liquid crystals are put between the TFT substrate 11 and the counter substrate 12.

A lower polarization plate 14 is bonded below the TFT substrate 11 and an upper polarization plate 13 is bonded above the counter substrate 12. The TFT substrate 11, the counter substrate 12, the lower polarization plate 14, and the upper polarization plate 13 bonded together are referred to as a liquid crystal display panel 10. A backlight is disposed at the back of the liquid crystal display panel 10. The backlight comprises a light source and various optical parts.

In FIG. 1, the backlight comprises an optical sheet group 16, a light guide plate 20, and a lower frame for housing the light guide plate, etc. in the order as they are situated from the side of the liquid crystal display panel 10. For the optical sheet group 16 in FIG. 1, three diffusion sheets 15 are used. The optical sheet group 16 may sometimes include a so-called prism sheet. The diffusion sheet 15 may comprise one or two sheet. The diffusion sheet 15 or the optical sheet group 16 is used by an optional number in accordance with required characteristics. The optical sheet group 16 is disposed over the light guide plate 20. The light guide plate 20 serves to direct light from a plurality of LEDs 30 as a uniform surface light source to the liquid crystal display panel 10. The light guide plate 20 has a thin flat plate shape.

The LEDs 30 and a reflection plate 60 for reflecting light from the LEDs and guiding the light to the side wall of the light guide plate 20 are disposed along the longer side in the inside of the lower frame 50 for housing the light guide plate 20, etc. In FIG. 1, the LEDs 30 and the reflection plate 60 are arranged along both of the longer sides in the inside of the lower frame 50, but they may be sometimes arranged only along one longer side.

FIG. 2 is a cross sectional schematic view on the side where LEDs 30 are arranged in FIG. 1. In FIG. 2, an LED 30 is disposed at the inner end of the lower frame 50. The LED 30 is disposed over the LED circuit substrate 31, and the LED circuit substrate 31 is disposed in close adhesion to the lower frame 50. Since the lower frame 50 is formed of a metal such as Al, it has good heat conductivity and can propagate and dissipate heat generated from the LED 30 efficiently.

In FIG. 2, light from the LED 30 is emitted upward. The upwardly emitting light is reflected at the reflection plate 60 and guided to the side surface of the light guide plate 20. A reflection sheet 40 is disposed below the light guide plate 20, and reflects light from the light guide plate 20 and guides the same to the optical sheet group 16 in FIG. 2. The optical sheet group 16 is mounted over the light guide plate 20. A not illustrated liquid crystal display panel is disposed over the optical sheet group 16.

The liquid crystal display device of FIG. 2 has a feature that the LED 30 and the LED circuit substrate 31 are provided in close adhesion to the lower surface of the lower frame 50. Thus, heat from the LED 30 can be efficiently conducted to the lower frame 50 to suppress increase in the temperature of the LED 30. When increase in the temperature of the LED can be suppressed, lowering of the emission efficiency of the LED can be suppressed and, consequently, power consumption can be suppressed. The present invention enables such configuration by using the reflection plate 60. Further, by using the reflection plate 60, light from the LED 30 can be efficiently guided to the side surface of the light guide plate 20 without close adhesion of the LED 30 to the light guide plate 20.

Further, since the LED 30 is heated to a high temperature, if it is in close adhesion to an optical part, there may be a risk that the optical part is strained due to thermal expansion, thereby lowering the light utilization efficiency. According to the configuration of the invention, since the LED 30 is in close adhesion only to the lower frame 50 formed of the metal, heat is conducted efficiently to the lower frame 50 and strain of the optical part can be prevented. Further, since the incident path of light, etc. can be controlled by fine adjustment of the reflection plate 60, temperature increase of the LED 20 can be suppressed efficiently by arranging the LEDs 30 mainly with a view point of heat conduction.

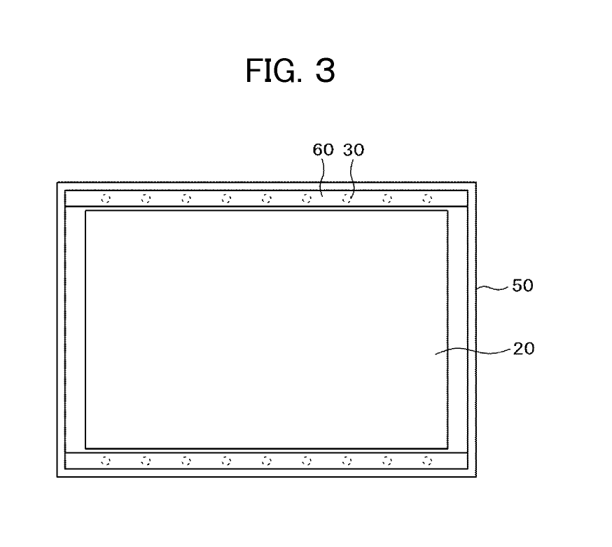

FIG. 3 is a schematic plan view that illustrates positions of the light guide plate 20, the reflection plate 60, LEDs 30, etc. provided in the lower frame 50 of the backlight. In FIG. 3, the light guide plate 20 is attached within the lower frame 50, and the reflection plate 60 is attached to the longer side in the inside of the lower frame 50. Since the LEDs 30 are arranged below the reflection plate 60, the LEDs 30 are indicated by dotted lines.

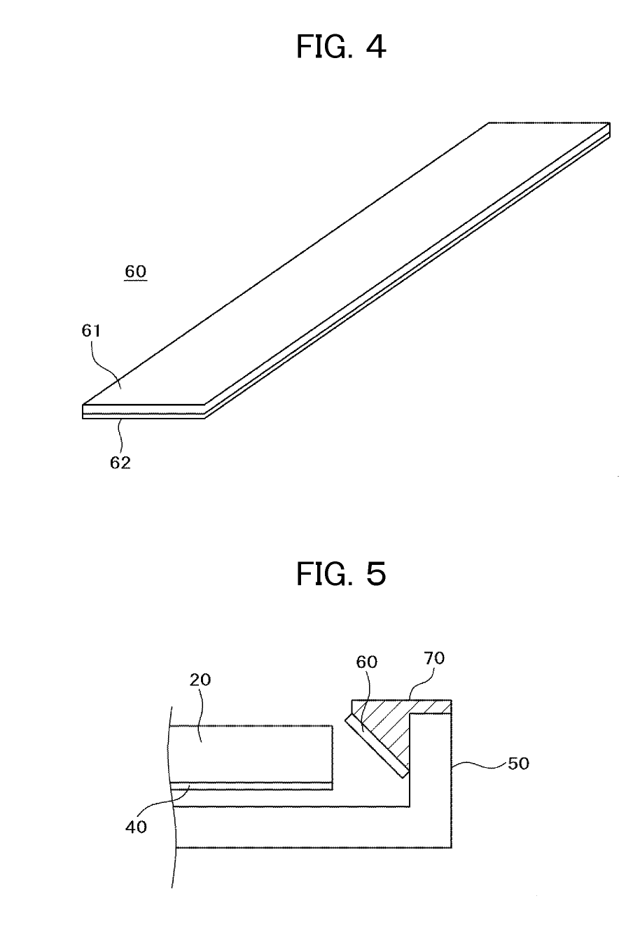

FIG. 4 is a perspective view of the reflection plate 60. In the reflection plate 60, a reflection surface 62 is formed on a base resin 61. The reflection surface 62 is formed by bonding a metal, etc. of high reflectance such as Al. As the base resin 61, PET, etc. can be used.

FIG. 5 is a cross sectional view illustrating an actual configuration in which a reflection plate 60 is attached. In FIG. 5, a resin mold 70 is attached to an upper portion of the lower frame 50, and the reflection plate 60 is attached to the inclined surface of the resin mold 70.

The reflection plate 60 is sometimes formed by coating the base resin with a metal or the like of high reflectance or sometimes formed of a material of high reflectance. The reflection plate 60 is sometimes formed by bonding or coating a metal or the like of high reflectance to the resin mold 70. Further, the resin mold 70 is sometimes formed of a material of high reflectance. While the LED 30 is not illustrated in FIG. 5, the LED 30 is attached in close adhesion to the lower frame 50.

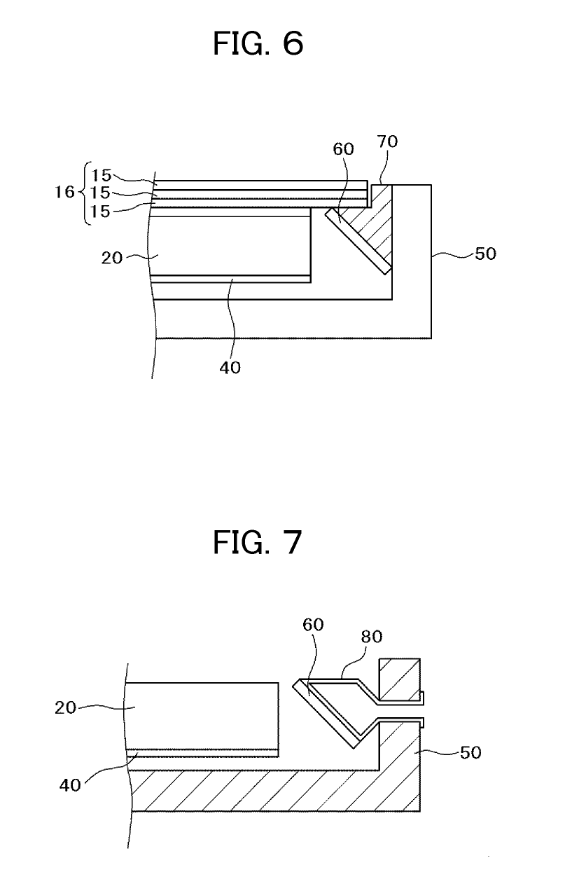

FIG. 6 illustrates another example of a configuration in which the reflection plate 60 is attached. In FIG. 6, a mold 70 for attaching a reflection plate 60 is bonded to the inside of the side wall of a lower frame 50, and the reflection plate 60 is bonded to the inclined surface of the mold 70. In FIG. 6, a step is formed to the mold 70, and an optical sheet group 16 is mounted on the step. While the LED 30 is not illustrated in FIG. 6, the LED 30 is attached in close adhesion to the lower frame 50.

FIG. 7 illustrates a further example of a structure in which a reflection plate 60 is attached. In FIG. 7, a snap fit 80 formed of a metal is inserted inside of the lower frame 50 through a hole formed in the side wall of the lower frame 50. The reflection plate 60 is attached to the inclined surface of the snap fit 80. Since this method does not require formation of the mold 70, the structure is simple and a manufacturing cost can be decreased. While the LED 30 is not illustrated also in FIG. 7, the LED 30 is attached in close adhesion to the lower frame 50.

### Second Embodiment

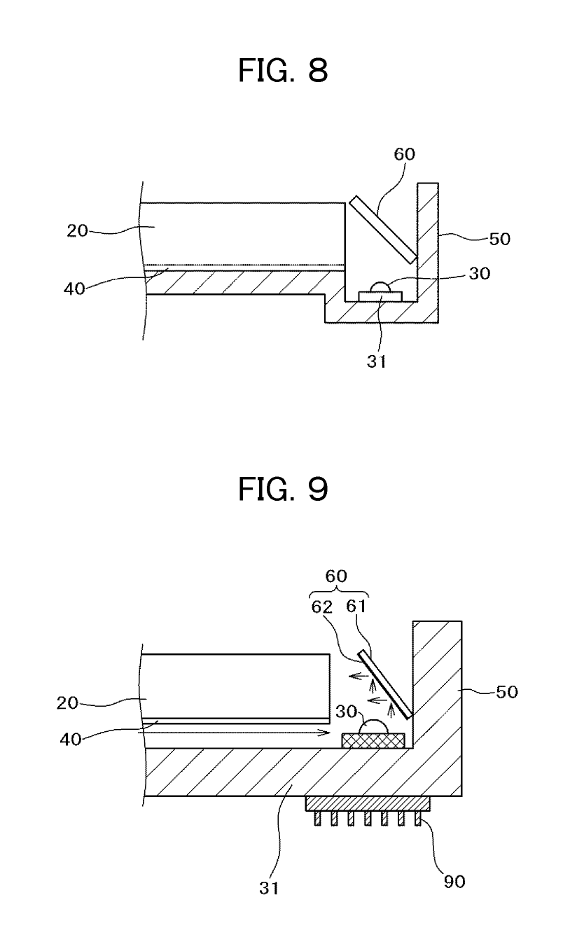

FIG. 8 illustrates a second embodiment of the invention. In FIG. 8, a concave portion is formed in a lower frame 50, and an LED 30 is disposed in the concave portion. In the same manner as the first embodiment, the LED 30 is in close adhesion to the concave portion of the lower frame 50 and heat from the LED 30 is dissipated efficiently by heat conduction.

This embodiment has a feature that the concave portion is formed to a portion of the lower frame 50 where the LED 30 is disposed, so that the thickness for other portions of the liquid crystal display device can be reduced. Light emitting upward from the LED 30 is reflected at the reflection plate 60 and incident on the side surface of the light guide plate 20 in the same manner as in the first embodiment.

Further, since the LED 30 heated to high temperatures may be in close adhesion only to the lower frame 50 without close adhesion to other optical parts, the effect due to strain cause by thermal expansion can be suppressed. Further, since the optical path can be finely controlled by the reflection plate 60 or the like, the LED 30 can be set mainly with a view point of thermal conduction to the lower frame 50 in the same manner as the first embodiment.

### Third Embodiment

FIG. 9 illustrates a third embodiment of the invention. In FIG. 9, fins 90 are formed as a heat sink for promoting the heat dissipation effect on the outer side of the bottom of the lower frame 50 but at a portion corresponding to the position at which the LED 30 is disposed. Heat conducted from the LED 30 to the lower frame 50 can be dissipated efficiently by the fins 90 and increase in the temperature of the LED 30 can be suppressed further efficiently. As the material of the heat dissipation fins 90, Al, Cu, etc. of good thermal conductivity are used. Heat radiation by the fins 90 may be increased preferably, for example, by a blackening treatment to Al or Cu.

In FIG. 9, since the LED 30 is disposed at the bottom of the lower frame 50, the heat can be dissipated efficiently by the fins 90 formed at the bottom of the lower frame 50. If the LED 30 is disposed on the side surface of the lower frame 50 as in the existent embodiment, since it is necessary to dispose the fins 90 also to the side surface of the lower frame 50 for efficient heat dissipation, the planar size of the liquid crystal display device is increased. On the other hand, in the configuration of the invention, the thickness of the liquid crystal display device is increased only partially by portions corresponding to the thickness of the fins 90 and the planar size of the liquid crystal display device does not change.

Since the LED 30 heated to high temperatures may be in close adhesion only to the lower frame without close adhesion to other optical parts, undesired effect due to strain caused by thermal expansion to the optical path can be suppressed. Further, since the optical path can be finely controlled by the reflection plate 60, etc. the LEDs 30 can be arranged mainly from a view point of heat conduction to the lower frame 50 in the same manner as in the first embodiment.

### Comparative Example

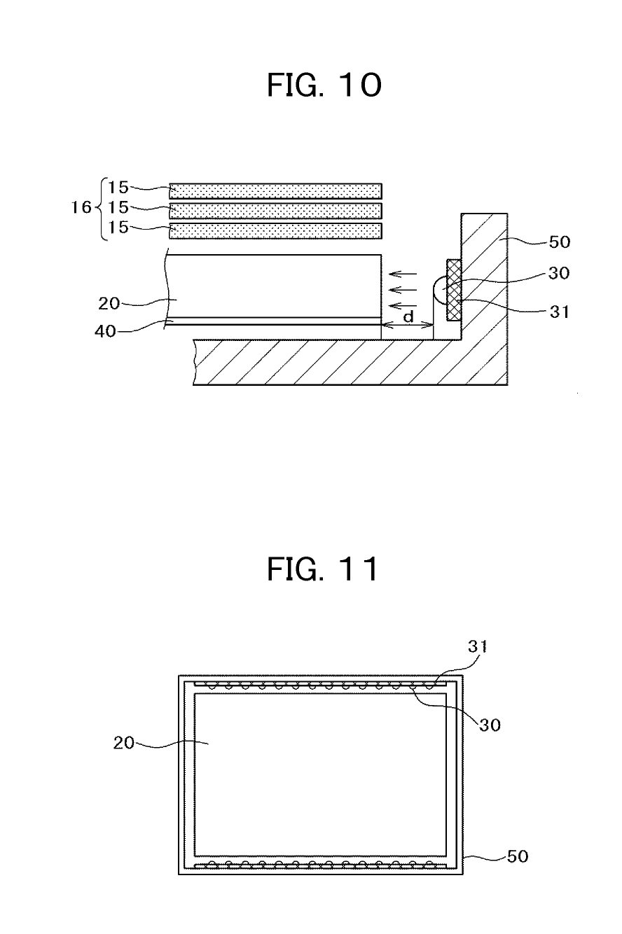

FIG. 10 is a cross sectional view illustrating a configuration of a comparative example in a backlight of a liquid crystal display device. FIG. 11 is a plan view of the backlight illustrated in FIG. 10. In FIG. 10, a light guide plate 20 is disposed inside of the lower frame 50, and an optical sheet group 16 such as a diffusion sheet 15, etc. is disposed over the light guide plate 20. A reflection sheet 40 is bonded below the light guide plate 20. The LED 30 is attached to the side wall of the lower frame 50, and light from the LED 30 is incident directly on the side surface of the light guide plate 20.

FIG. 11 illustrates a state in which the light guide plate 20 is disposed in the lower frame 50, and the LED 30 is disposed by way of a circuit substrate 31 on the inside of the side wall of the lower frame 50.

In the configuration of FIG. 10 and FIG. 11, since the LED 30 is attached directly to the side wall of the lower frame 50, efficiency of heat conduction can be ensured. On the other hand, a distance d between the light guide plate 20 and the LED 30 illustrated in FIG. 10 gives a significant effect on the amount of light incident on the light guide plate 20. If the light guide plate 20 is disposed at a localized position in the lower frame 50, distribution of brightness is caused in the right to left direction of a display screen.

Accordingly, if it is intended to obtain uniform brightness at the display screen in the configuration as illustrated in FIG. 10, dimensional accuracy of parts such as the lower frame 50, the light guide plate 20, LED 30, etc. has to be increased, which will increase the cost.

Further, if the fins 90 as shown in the third embodiment are attached to the side wall of the lower frame 50 in order to further improve the heat dissipation from the LED 30, the planar size of the liquid crystal display device is increased. Accordingly, such an arrangement is disadvantageous in the case of a display device where the planar size of the liquid crystal display device is restricted.

What is claimed is:

1. A liquid crystal display device comprising:
a liquid crystal display panel, and
a backlight, wherein
the backlight has a light guide plate, LEDs as a light source, and a reflection plate within a lower frame formed of a metal,
the LEDs are arranged in the inside at the bottom of the lower frame, and
light is emitted from the LEDs in the direction in which the liquid crystal display panel is arranged, reflected at the reflection plate, and incident on the side surface of the light guide plate.

2. A liquid crystal display device according to claim 1, wherein
the lower frame has an outwardly convex shape formed at a portion thereof, and
the LEDs are arranged in a concave portion of the lower frame that corresponds to the portion having the outwardly convex shape.

3. A liquid crystal display device according to claim 1, wherein
fins are formed at the outside of the lower frame in association with the LEDs arranged inside of the lower frame.
